(19) United States
(12) Patent Application Publication
(10) Pub. No.: US 2019/0004465 A1
(43) Pub. Date: Jan. 3, 2019

(54) IMAGE FORMING APPARATUS AND DEVELOPING DEVICE

(71) Applicant: FUJI XEROX CO., LTD., Tokyo (JP)

(72) Inventors: Yoshitaka NAKAJIMA, Kanagawa (JP); Yoshifumi OZAKI, Kanagawa (JP); Masanori KATO, Kanagawa (JP); Fumiyuki HONDA, Kanagawa (JP); Tomoyuki YOSHII, Kanagawa (JP); Kenta URAYAMA, Kanagawa (JP); Junichi UCHIYAMA, Kanagawa (JP); Norihiro TAMAZAWA, Kanagawa (JP); Shiho MATSUDA, Kanagawa (JP)

(73) Assignee: FUJI XEROX CO., LTD., Tokyo (JP)

(21) Appl. No.: 15/915,560

(22) Filed: Mar. 8, 2018

(30) Foreign Application Priority Data
Jul. 3, 2017 (JP) 2017-130418

(51) Int. Cl. G03G 15/00; G03G 15/08

(52) U.S. Cl. CPC G03G 15/6529; G03G 2215/0888; G03G 15/0829; G03G 15/657

(57) ABSTRACT

An image forming apparatus includes: an image carrier that carries an image; a transport-path forming part that forms a transport path for developer used to develop the image carried by the image carrier; a transport member that transports the developer in the transport path; and a concentration detector that detects toner concentration in the developer in the transport path. The transport path includes a first portion and a second portion. Difference in sectional area between the second portion and the transport member in a direction intersecting a direction in which the developer is transported is smaller than difference in sectional area between the first portion and the transport member. The second portion is located downstream of the first portion in the direction in which the developer is transported. The concentration detector is disposed in the second position of the transport path.

### CROSS-REFERENCE TO RELATED APPLICATIONS

This application is based on and claims priority under 35 USC 119 from Japanese Patent Application No. 2017-130418 filed Jul. 3, 2017.

### BACKGROUND

### Technical Field

The present invention relates to image forming apparatuses and developing devices.

### SUMMARY

According to an aspect of the invention, there is provided an image forming apparatus including: an image carrier that carries an image; a transport-path forming part that forms a transport path for developer used to develop the image carried by the image carrier; a transport member that transports the developer in the transport path; and a concentration detector that detects toner concentration in the developer in the transport path. The transport path includes a first portion and a second portion, difference in sectional area between the first portion and the transport member in a direction intersecting a direction in which the developer is transported being different from difference in sectional area between the second portion and the transport member. The difference in sectional area between the second portion and the transport member in the direction intersecting the direction in which the developer is transported is smaller than the difference in sectional area between the first portion and the transport member. The second portion is located downstream of the first portion in the direction in which the developer is transported. The concentration detector is disposed in the second position of the transport path, and a≤0.7b where a is difference between a radius of the second portion of the transport path and a radius of the transport member in the second portion, and b is a length from the upstream end of the second portion to an upstream end of the concentration detector in the direction in which the developer is transported.

### BRIEF DESCRIPTION OF THE DRAWINGS

Exemplary embodiment of the present invention will be described in detail based on the following figures, wherein:

FIG. 1 schematically shows the configuration of an image forming apparatus used in an exemplary embodiment of the present invention;

FIG. 2 is a sectional view of a toner-image forming unit of the image forming apparatus in FIG. 1;

FIG. 3 shows a first example of a transport path and a first example of a transport member of the toner-image forming unit shown in FIG. 2;

FIG. 4 shows a sectional view of the transport member shown in FIG. 3, taken along line IV-IV;

FIG. 5 shows the movement of developer in the transport path shown in FIG. 3;

FIG. 6 shows the result of measuring the pressures applied to the developer in the transport path shown in FIG. 3; and

FIG. 7 shows a second example of a transport path and a transport member of the toner-image forming unit shown in FIG. 2.

### DETAILED DESCRIPTION

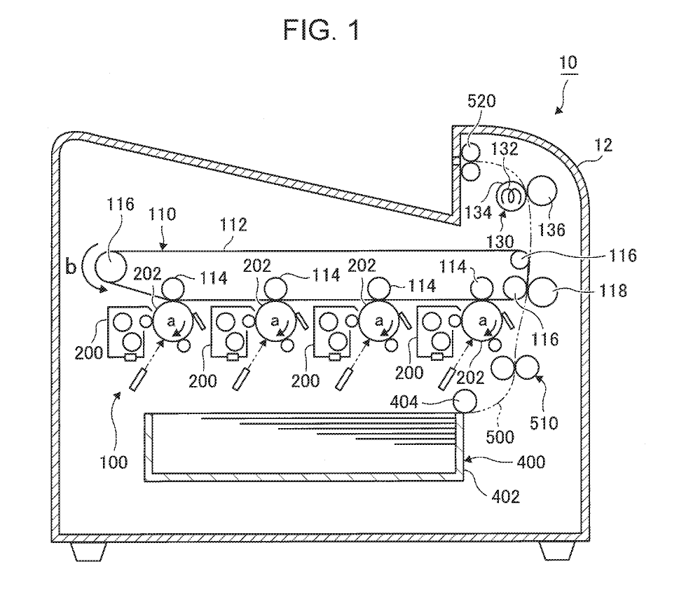

An exemplary embodiment of the present invention will be described in detail below with reference to the drawings. FIG. 1 shows an image forming apparatus 10, which is an exemplary embodiment of the present invention.

As shown in FIG. 1, the image forming apparatus 10 includes an image forming apparatus body 12. The image forming apparatus body 12 accommodates an image forming part 100 that forms an image, a supply device 400, and a transport path 500.

The image forming part 100 includes, for example, four toner-image forming units 200, which form toner images of different colors (e.g., yellow, magenta, cyan, and black). The toner-image forming units 200 each include a photoconductor drum 202, which is an example of an image carrier that carries an image and on the surface of which a toner image is formed. The photoconductor drum 202 rotates in the direction of an arrow a. The details of the toner-image forming units 200 will be given below.

The image forming part 100 further includes a transfer device 110. The transfer device 110 includes, for example, an endless intermediate transfer body 112 and four first-transfer members 114 corresponding to the four toner-image forming units 200.

The intermediate transfer body 112 is stretched around the four first-transfer members 114 and, for example, three support rollers 116 and revolves in the direction of an arrow b.

The first-transfer members 114 are, for example, roller-shaped and are disposed so as to oppose the corresponding photoconductor drums 202 with the intermediate transfer body 112 therebetween. First-transfer bias voltages for transferring the toner images formed on the photoconductor drums 202 to the intermediate transfer body 112 are applied to the first-transfer members 114.

The transfer device 110 also includes a second-transfer member 118. The second-transfer member 118 is, for example, roller-shaped and is disposed so as to oppose one of the support rollers 116 with the intermediate transfer body 112 therebetween. A second-transfer bias voltage for transferring the toner images, which have been first-transferred from the four photoconductor drums 202 to the surface of the intermediate transfer body 112 so as to be superimposed on one another, to a recording medium, such as a sheet, is applied to the second-transfer member 118.

The image forming part 100 also includes a fixing device 130. The fixing device 130 includes a heating roller 134 having a heat source 132, and a pressure roller 136 that presses the recording medium against the heating roller 134. The fixing device 130 fixes the toner image to the recording medium by using heat and pressure.

The supply device 400 supplies a recording medium to the image forming part 100 and includes a storage part 402 in which a stack of recording media are stored, and a feed roller 404 that feeds the recording media stored in the storage part 402 to the image forming part 100.

In the transport path 500, the recording medium is transported from the supply device 400 to the image forming part 100, where an image is formed, and then to the outside of the image forming apparatus body 12. The feed roller 404, registration rollers 510, the second-transfer member 118, the fixing device 130, and discharge rollers 520 are arranged in this order from the upstream side in the direction in which the recording medium is transported (recording-medium transport direction) along the transport path 500.

The registration rollers 510 temporarily stop the movement of the distal end portion of the recording medium and restart the movement of the distal end portion of the recording medium in accordance with the timing when an image is formed in the image forming part 100.

The discharge rollers 520 discharge the recording medium having the toner image fixed by the fixing device 130 to the outside of the image forming apparatus body 12.

As described above, in the image forming apparatus 10, the supply device 400 supplies a recording medium, the image forming part 100 forms a toner image thereon, and the recording medium having the toner image is discharged to the outside of the image forming apparatus body 12.

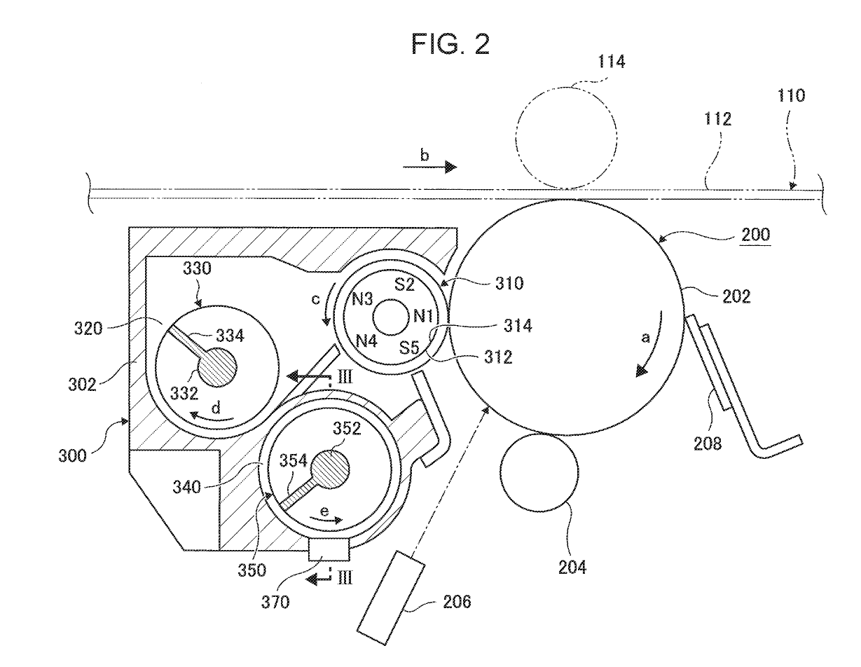

FIG. 2 shows one of the toner-image forming units 200. As shown in FIG. 2, the toner-image forming unit 200 includes the photoconductor drum 202, a charging device 204 that charges the photoconductor drum 202, a latent-image forming device 206 that forms a latent image by, for example, irradiating the surface of the photoconductor drum 202 charged by the charging device 204 with light, a developing device 300 that develops the latent image formed by the latent-image forming device 206 into a toner image using two-component developer, and a cleaning device 208 that cleans the surface of the photoconductor drum 202 after the toner image is first-transferred to the intermediate transfer body 112.

The developing device 300 develops the latent image using developer composed of, for example, negatively charged nonmagnetic toner and, for example, positively charged magnetic carrier. The developing device 300 includes a developing device body 302, in which a developing roller 310 is disposed. The developing device body 302 is an example of a transport-path forming part that forms a second transport path 340 (described below).

The developing roller 310 includes, for example, a cylindrical magnet member 312 and a tubular developing sleeve 314 that covers the magnet member 312 and that rotates in the direction of an arrow c while being supported by the magnet member 312.

The magnet member 312 has, for example, five magnetic poles. More specifically, the magnet member 312 has, for example, a magnetic pole N1 for developing image, a magnetic pole S2 for transporting developer, a magnetic pole N3 for separating developer, a magnetic pole N4 for separating developer, and a magnetic pole S5 for attracting developer. The magnetic poles N1, N3, and N4 are N poles, and the magnetic poles S2 and S2 and S5 are S poles.

The developing device body 302 forms a first transport path 320, in which a first transport member 330 is disposed. The first transport member 330 has a shaft part 332 and a spiral blade part 334 formed on the shaft part 332. The first transport member 330 rotates about the shaft part 332 in the direction of an arrow d and transports the developer while stirring, so as to push out with the blade part 334. More specifically, the first transport member 330 transports the developer in the first transport path 320, from the far side toward the near side in FIG. 2.

The developing device body 302 also forms the second transport path 340. The second transport path 340 is an example of a transport path for the developer used to develop the image held on the photoconductor drum 202. A second transport member 350 is disposed in the second transport path 340.

The second transport member 350, which is an example of a transport member, transports the developer in the second transport path 340 by rotating. The second transport member 350 includes a shaft part 352 and a blade part 354, which is an example of a blade part, formed on at least one portion of the shaft part 352. The second transport member 350 rotates about the shaft part 352 in the direction of an arrow e and transports the developer while stirring, so as to push out with the blade part 354. More specifically, the second transport member 350 transports the developer in the second transport path 340 from the near side toward the far side in the sheet of FIG. 2. The details of the second transport member 330 will be given below.

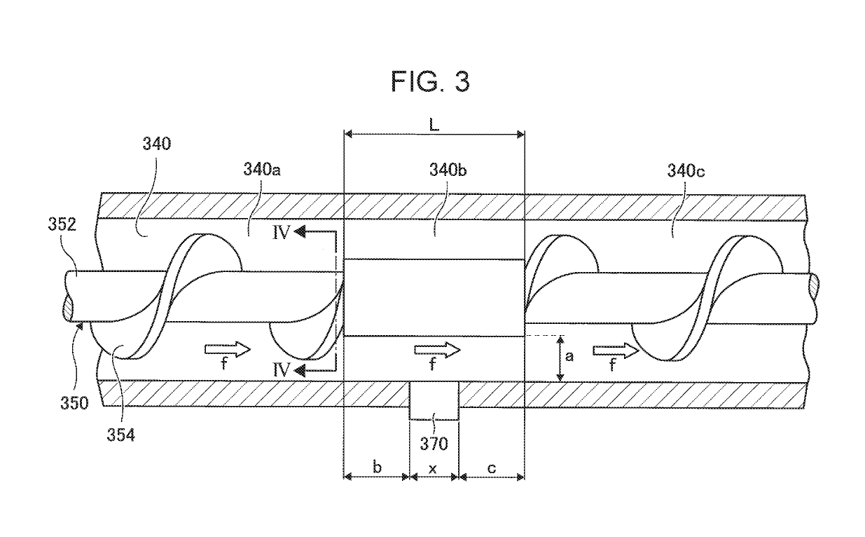

The developing device 300 includes a concentration detector 370 for detecting the toner concentration in the developer in the second transport path 340. The concentration detector 370 is disposed in a second portion 340b (described below, see FIG. 3) of the second transport path 340. The concentration detector 370 is a magnetic permeability sensor that detects the toner concentration in the developer by measuring the magnetic permeability of the developer.

FIG. 3 is a sectional view showing a first example of the second transport path 340 and a first example of the second transport member 350, taken along line III-III in FIG. 2. As shown in FIG. 3, the second transport path 340 has a first portion 340a and a second portion 340b. The difference in the sectional area between the first portion 340a and the second transport member 350, such as the shaft part 352, in a direction (an “intersecting direction”) intersecting the direction in which the developer is transported (a “developer transport direction”), shown by arrows f, is different from the difference in the sectional area between the second portion 340b and the second transport member 350.

The difference in the sectional area between the second portion 340b and the second transport member 350 in the intersecting direction is smaller than the difference in the sectional area between the first portion 340a and the second transport member 350 in the intersecting direction. The second portion 340b is located downstream of the first portion 340a in the developer transport direction.

The second transport path 340 further has a third portion 340c. The difference in the sectional area between the third portion 340c and the second transport member 350 in the intersecting direction is different from the difference in the sectional area between the second portion 340b and the second transport member 350 in the intersecting direction. The difference in the sectional area between the third portion 340c and the second transport member 350 in the intersecting direction is larger than the difference in the sectional area between the second portion 340b and the second transport member 350 in the intersecting direction. The third portion 340c is located downstream of the second portion 340b in the developer transport direction.

The difference in the sectional area between the first portion 340a and the second transport member 350, such as the shaft part 352, in the intersecting direction is equal to the difference in the sectional area between the third portion 340c and the second transport member 350.

The sectional areas of the first portion 340a, the second portion 340b, and the third portion 340c of second transport path 340 in the intersecting direction are the same. In contrast, the sectional area, in the intersecting direction, of a portion of the second transport member 350 located in the second portion 340b is larger than that of a portion located in the first portion 340a, and the sectional area, in the intersecting direction, of a portion of the second transport member 350 located in the third portion 340c is smaller than that of the portion located in the second portion 340b. The sectional areas, in the intersecting direction, of the portions of the second transport member 350 located in the first portion 340a and the third portion 340c are equal.

The second transport member 350 has the blade parts 354 on the portions located in the first portion 340a and the third portion 340c, but not on the portion located in the second portion 340b. Hence, compared with a case where the blade part 354 is formed on the portion located in the second portion 340b, the change in the bulk density of the developer occurring near the concentration detector 370 due to the change in the position of the blade part 354 is small. The bulk density is obtained by filling a container having a certain capacity with a powder and by dividing the content (weight) by the volume thereof. The bulk density is a counterpart of the true density, which is calculated from the volume of particles themselves (i.e., the volume of a powder filling a container having a certain capacity after removing gaps from the volume of the container).

In the second portion 340b, the shaft part 352 faces the inner wall of the second transport path 340. Hence, compared with a case where the blade part 354 faces the inner wall of the second transport path 340 in the second portion 340b, the change in the bulk density of the developer occurring near the concentration detector 370 due to the change in the position of the blade part 354 is small.

In the description below, the difference between the radius (inside radius) of the second portion 340b of the second transport path 340 and the radius of the portion of the second transport member 350 located in the second portion 340b is assumed to be a. The length from the upstream end of the second portion 340b to the upstream end of the concentration detector 370 in the developer transport direction is assumed to be b.

In the developing device 300, the radius (inside radius) of the second transport path 340 and the radius of the portion of the second transport member 350 located in the second portion 340b are determined such that the difference in radius a is 3.5 mm.

Furthermore, in the developing device 300, the change in the bulk density of the developer occurring near the concentration detector 370 is reduced by using the result of measuring the pressures applied to the developer inside the second transport path 340, and the length b is determined based on, for example, the ratio with respect to the difference in radius a such that the pressure applied to the developer near the concentration detector 370 falls within a predetermined range.

More specifically, it is determined as: b≥5.0 mm, that is, b≥a/0.7.

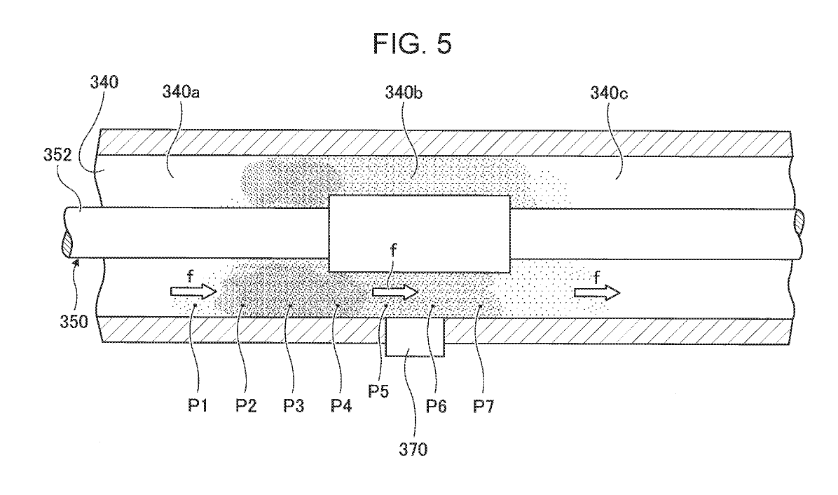

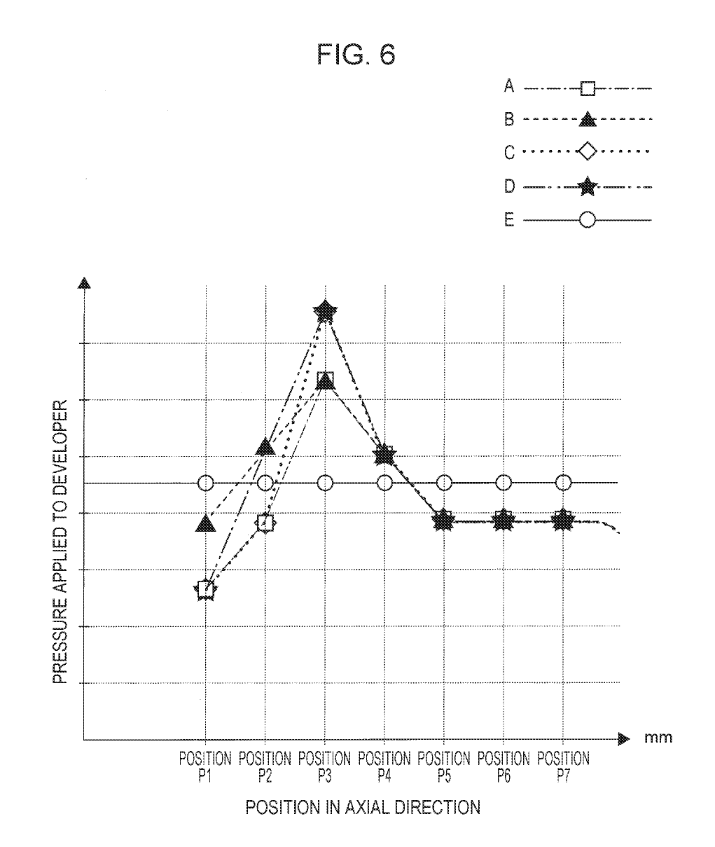

The result of measuring the pressures applied to the developer in the second transport path 340 and the reason why the distance b is determined to be greater than or equal to a/0.7 by using this result will be described below (see FIGS. 5 and 6).

Furthermore, in the developing device 300, when the length of the second portion 340b of the second transport path 340 in the developer transport direction is assumed to be L, the length of the concentration detector 370 in the developer transport direction is assumed to be X, and the length from the downstream end of the concentration detector 370 to the downstream end of the second portion 340b in the developer transport direction is assumed to be length c, the length c is determined as: L−(0.7a+X)≥c.

More specifically, for example, it is determined that c=5.0 mm, when L=13 mm, a=3.5 mm, and X=3.0 mm.

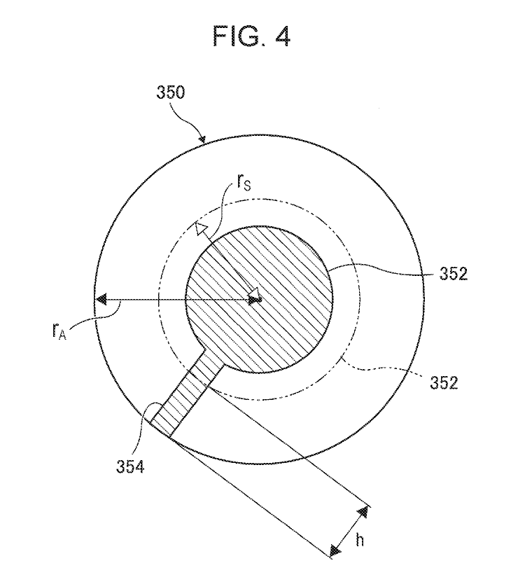

FIG. 4 shows the sectional view of the second transport member 350 taken along line IV-IV in FIG. 3. When the height of a portion of the blade part 354 projecting from the portion of the shaft part 352 located in the second portion 340b toward the inner wall of the second transport path 340 is assumed to be h, the radius of a portion of the shaft part 352 located in the second portion 340b of the second transport path 340 is assumed to be r_{S}, and the radius of the blade part 354 of the second transport member 350 is assumed to be r_{A}, as shown in FIG. 4, h>(r_{A}−r_{S}).

More specifically, for example, r_{A}=11 mm, r_{S}=5 mm, and h=8 mm.

Hence, compared with a case where h≤(r_{A}−r_{S}), more developer moves from the first portion 340a to the second portion 340b.

FIG. 5 shows the movement of the developer in the second transport path 340, and more specifically, the movement of the developer in the second portion 340b of the second transport path 340, in a portion on the upstream side of the second portion 340b, and in a portion downstream of the second portion 340b in the developer transport direction. In FIG. 5, for simplicity's sake, the blade parts 354 of the second transport member 350 is not shown.

FIG. 5 shows a position P1, a position P2, a position P3, a position P4, a position P5, a position P6, and a position P7 that specify positions in the second transport path 340. These positions P1 to P7 are arranged in this order from the upstream side in the developer transport direction (shown by the arrows f). The positions P1, P2, and P3 are in the first portion 340a of the second transport path 340. The position P4 is located at the boundary between the first portion 340a and the second portion 340b of the second transport path 340.

The positions P5, P6, and P7 are in the second portion 340b of the second transport path 340. The positions P1 to P7 are located at equal intervals (5 mm) in the developer transport direction.

In the second transport path 340, the developer pushed by the blade part 354 moves in the sequence the positions P1, P2, and P3, and, at the position P4, the developer accumulates because the difference in the sectional area between the second transport path 340 and the second transport member 350 in the intersecting direction (in other words, the space through which the developer passes) is reduced. The accumulation of the developer affects the upstream side of the position P4 in the second transport path 340. More specifically, the accumulation of the developer gradually occurs from the upstream side (i.e., the positions P2 and P3) in the developer transport direction, not only near the position P4.

Although the developer accumulates near the position P4, the developer near the position P4 is pushed by the developer moving from the upstream side by being pushed by the blade part 354 and is transported toward the downstream side (i.e., the positions P6 and P7).

As described above, the developer accumulates in the second transport path 340, and the extent of the accumulation varies from position to position in the second transport path 340. Hence, the developer is subjected to different pressures depending on the position in the second transport path 340. Even at the same position in the second transport path 340, the extent of the accumulation of the developer may change with time. Hence, the pressure applied to the developer at the same position in the second transport path 340 may change with time.

When the pressure applied to the developer changes, the bulk density of the developer changes. When the bulk density of the developer changes, the result of detecting the toner concentration in the developer, obtained with the concentration detector 370, may change. To reduce the change in the result of detecting the toner concentration with the concentration detector 370, the concentration detector 370 is disposed at a position in the second transport path 340 where the change in the pressure applied to the developer is small and where the change in the bulk density of the developer is small.

FIG. 6 shows the result of measuring the pressure applied to the developer in the second transport path 340. In FIG. 6, the horizontal axis shows positions in the second transport path 340 in the developer transport direction and the distances from the reference position located upstream of the position P1 to the respective positions in the developer transport direction. The unit used in the horizontal axis of the FIG. 6 is millimeter (mm).

Lines A, B, C, and D in FIG. 6 show the pressures applied to the developer at the respective positions in the second transport path 340 when different amounts of developer are transported in the second transport path 340. The amount of developer transported in the second transport path 340 increases in the sequence the case shown by the line A (smallest), the case shown by the line B, the case shown by the line C, and the case shown by the line D (largest).

A line E in FIG. 6 shows the result of measuring the pressures applied to the developer in the second transport path 340 in a comparison example (not shown) in which the difference in the sectional area between the second transport path 340 and the shaft part 352 in the intersecting direction is constant.

The positions P1 to P7 on the horizontal axis in FIG. 6 correspond to the positions P1 to P7 shown in FIG. 5.

As shown in FIG. 6, in any of the cases shown by the lines A to D, the pressure applied to the developer increases as the developer is transported in the sequence the position P1 and the position P2, and, at the position P3, the pressure applied to the developer becomes maximum because the blade part 354 pushes the accumulated developer in the transport direction.

In any of the cases shown by the lines A to D, after the pressure applied to the developer becomes maximum at the position P3, the pressure applied to the developer decreases as the developer is transported in the sequence the position P4 and the position P5. In any of the cases shown by the lines A to D, the pressures applied to the developer at the positions P5, P6, and P7 are substantially constant. In any of the cases shown by the lines A to D, the pressure applied to the developer drops after the developer passes through the position P7.

The above measurement result shows that it is desirable that the concentration detector 370 be disposed in the second transport path 340, downstream of the position P5, where the change in the pressure applied to the developer is small, and thus, the change in the bulk density of the developer is also small, and on the upstream side of the position P7 in the developer transport direction.

The position P4 is the upstream end of the second portion 340b in the developer transport direction. The position P5 is at a distance of 5 mm to the downstream side of the position P4 in the developer transport direction, and the position P7 is at a distance of 15 mm to the downstream side of the position P4 in the developer transport direction. Therefore, in the developing device 300, the concentration detector 370 is disposed in an area extending from a distance of 5 mm to 15 mm from the position P4, which is the upstream end of the second portion 340b.

To enable the concentration detector 370 to be disposed as above, the length b (i.e., the length from the upstream end of the second portion 340b to the upstream end of the concentration detector 370 in the developer transport direction) needs to be 5 mm or more. The relationship between the length b and the difference in radius a (i.e., the difference in the radius between the second portion 340b of the second transport path 340 and the portion of the second transport member 350 located in the second portion 340b) is b≥a/0.7, since a is 3.5 mm.

By disposing the concentration detector 370 as described above, the concentration detector 370 is located at a position in the second transport path 340 where the pressure applied to the developer falls within the predetermined range.

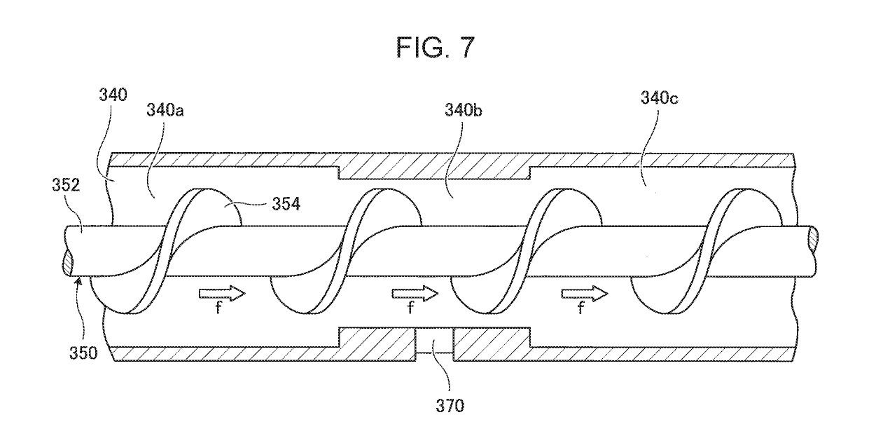

FIG. 7 shows a second example of the second transport path 340 and a second example of the second transport member 350. As shown in FIG. 7, also in these second examples, similarly to the first examples described above, the difference in the sectional area between the second portion 340b and the second transport member 350 in the intersecting direction is smaller than the difference in the sectional area between the first portion 340a and the second transport member 350 in the intersecting direction, and the difference in the sectional area between the third portion 340c and the second transport member 350 in the intersecting direction is larger than the difference in the sectional area between the second portion 340b and the second transport member 350 in the intersecting direction. The difference in the sectional area between the first portion 340a and the second transport member 350 in the intersecting direction and the difference in the sectional area between the second portion 340c and the second transport member 350 in the intersecting direction are equal.

In these second examples, the sectional areas of the portions of the second transport member 350 located in the first portion 340a, the second portion 340b, and the third portion 340c in the intersecting direction are the same. In contrast, the sectional area of the second portion 340b is smaller than that of the first portion 340a, the sectional area of the third portion 340c is larger than that of the second portion 340b, and the sectional areas of the first portion 340a and the third portion 340c are equal.

The above-described first examples and the second examples may be combined. That is, it may be configured such that the sectional area of the portion of the second transport member 350 located in the second portion 340b is larger than the sectional areas of the portions of the second transport member 350 located in the first portion 340a and the second portion 340c, and the sectional area of the second portion 340b of the second transport path 340 is smaller than the sectional areas of the first portion 340a and the third portion 340c, such that the difference in the sectional area between the second portion 340b and the second transport member 350 is smaller than the difference in the sectional area between the first portion 340a and the second transport member 350 and the difference in the sectional area between the second portion 340c and the second transport member 350.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
an image carrier that carries an image;
a transport-path forming part that forms a transport path for developer used to develop the image carried by the image carrier;
a transport member that transports the developer in the transport path; and
a concentration detector that detects toner concentration in the developer in the transport path, wherein
the transport path includes a first portion and a second portion, difference in sectional area between the first portion and the transport member in a direction intersecting a direction in which the developer is transported being different from difference in sectional area between the second portion and the transport member,
the difference in sectional area between the second portion and the transport member in the direction intersecting the direction in which the developer is transported is smaller than the difference in sectional area between the first portion and the transport member,
the second portion is located downstream of the first portion in the direction in which the developer is transported,
the concentration detector is disposed in the second portion of the transport path, and,
a≤0.7b where a is difference between a radius of the second portion of the transport path and a radius of the transport member in the second portion, and b is a length from an upstream end of the second portion to an upstream end of the concentration detector in the direction in which the developer is transported.

2. The image forming apparatus according to claim 1, wherein
the transport member has a shaft part, and
a sectional area of a portion of the shaft part located in the second portion is larger than a sectional area of a portion of the shaft part located in the first portion.

3. The image forming apparatus according to claim 2, wherein the transport member has a blade part on at least a portion of the shaft part located in the first portion and does not have the blade part on the portion of the shaft part located in the second portion.

4. The image forming apparatus according to claim 2, wherein, in the second portion, the shaft part faces an inner wall of the transport path.

5. The image forming apparatus according to claim 3, wherein, in the second portion, the shaft part faces an inner wall of the transport path.

6. The image forming apparatus according to claim 3, wherein h>(r_{A}−r_{S}) where h is a height of the blade part projecting from the portion of the shaft part located in the second portion toward an inner wall of the transport path, r_{S} is a radius of the portion of the shaft part located in the second portion, and r_{A} is a radius of the blade part of the transport member.

7. The image forming apparatus according to claim 4, wherein h>(r_{A}−r_{S}) where h is a height of the blade part projecting from the portion of the shaft part located in the second portion toward the inner wall of the transport path, r_{S} is a radius of the portion of the shaft part located in the second portion, and r_{A} is a radius of the blade part of the transport member.

8. The image forming apparatus according to claim 5, wherein h>(r_{A}−r_{S}) where h is a height of the blade part projecting from the portion of the shaft part located in the second portion toward the inner wall of the transport path, r_{S} is a radius of the portion of the shaft part located in the second portion, and r_{A} is a radius of the blade part of the transport member.

9. The image forming apparatus according to claim 1, wherein a sectional area of the second portion of the transport path is smaller than a sectional area of the first portion of the transport path.

10. The image forming apparatus according to claim 2, wherein a sectional area of the second portion of the transport path is smaller than a sectional area of the first portion of the transport path.

11. The image forming apparatus according to claim 3, wherein a sectional area of the second portion of the transport path is smaller than a sectional area of the first portion of the transport path.

12. The image forming apparatus according to claim 4, wherein a sectional area of the second portion of the transport path is smaller than a sectional area of the first portion of the transport path.

13. The image forming apparatus according to claim 5, wherein a sectional area of the second portion of the transport path is smaller than a sectional area of the first portion of the transport path.

14. The image forming apparatus according to claim 6, wherein a sectional area of the second portion of the transport path is smaller than a sectional area of the first portion of the transport path.

15. The image forming apparatus according to claim 7, wherein a sectional area of the second portion of the transport path is smaller than a sectional area of the first portion of the transport path.

16. The image forming apparatus according to claim 8, wherein a sectional area of the second portion of the transport path is smaller than a sectional area of the first portion of the transport path.

17. A developing device comprising:
a transport-path forming part that forms a transport path for developer used to develop an image carried by an image carrier;
a transport member that transports the developer in the transport path; and
a concentration detector that detects toner concentration in the developer in the transport path, wherein
the transport path includes a first portion and a second portion, difference in sectional area between the first portion and the transport member in a direction intersecting a direction in which the developer is transported being different from difference in sectional area between the second portion and the transport member,
the difference in sectional area between the second portion and the transport member in the direction intersecting the direction in which the developer is transported is smaller than difference in sectional area between the first portion and the transport member,
the second portion is located downstream of the first portion in the direction in which the developer is transported,
the concentration detector is disposed in the second position of the transport path, and
a≤0.7b where a is a difference between a radius of the second portion of the transport path and a radius of the transport member in the second portion, and b is the length from the upstream end of the second portion to an upstream end of the concentration detector in the direction in which the developer is transported.

18. A developing device comprising:
a transport-path forming part that forms a transport path for developer used to develop an image carried by an image carrier;
a transport member that transports the developer in the transport path; and
a concentration detector that detects toner concentration in the developer in the transport path,
wherein the concentration detector is disposed at a position in the transport path where pressure applied to the developer falls within a predetermined range.
